(19) United States
(12) Patent Application Publication
(10) Pub. No.: US 2023/0085192 A1
(43) Pub. Date: Mar. 16, 2023

(54) SYSTEMS AND METHODS FOR TRAFFIC CONTROL

(71) Applicant: HERE GLOBAL B.V., EINDHOVEN (NL)

(72) Inventors: Jeremy Michael Young, Chicago, IL (US); Leon Stenneth, Chicago, IL (US); Jerome Beaurepaire, Berlin (DE)

(73) Assignee: HERE GLOBAL B.V., EINDHOVEN (NL)

(21) Appl. No.: 17/474,116

(22) Filed: Sep. 14, 2021

(51) Int. Cl. G08G 1/01; G08G 1/017; G08G 1/087

(52) U.S. Cl. CPC G08G 1/0145; G08G 1/0133; G08G 1/017; G08G 1/087

(57) ABSTRACT

Systems and methods for traffic control and route guidance are provided. In some aspects, a method for controlling traffic includes receiving vehicle information for a vehicle navigating a location on a road network and identifying a maneuver of the vehicle at the location based on the vehicle information. The method also includes determining an intrusiveness of the maneuver made by the vehicle, and controlling traffic at the location based on the intrusiveness of the vehicle.

### BACKGROUND

The present disclosure relates generally to systems, methods and products for traffic control.

Road traffic is managed in a variety of ways. For instance, markers, signs, and road features (e.g., speed bumps, cones) are often placed at different public locations to passively control behavior. In more active approaches, the operation of electronic traffic control devices, such as traffic signals, are optimized to control traffic movement based on historical traffic patterns as well as live data obtained using sensors positioned about the roadway (e.g., cameras, infrared sensors, microwave sensors, etc.). Traffic information is also commonly acquired and used by navigation systems and services to provide real-time travel estimates and routes. By selecting routes that avoid high-traffic areas, users can also indirectly influence traffic conditions.

There are various technologies currently available that provide traffic information. For example, the Traffic Message Channel (TMC) is a technology for broadcasting traffic and travel information to motor vehicle drivers. The information is digitally coded using the Radio Data System (RDS) and provided by conventional FM radio broadcasts. It can also be transmitted on Digital Audio Broadcasting (DAB) or satellite radio. Yet another example technology is the Transport Protocol Experts Group (TPEG), which was designed for the transmission of language independent multi-modal traffic and travel information. While existing traffic information systems provide broad indications of traffic levels along roadways over time, challenges remain in developing efficient and immediate techniques for identifying and controlling important or dangerous events that affect traffic at specific locations on roadways.

### SUMMARY

The present disclosure overcome the shortcomings of prior technologies. In particular, a novel approach for traffic control is provided, as detailed below.

In accordance with one aspect of the disclosure, a method for controlling traffic is provided. The method includes receiving vehicle information for a vehicle navigating a location on a road network, and identifying a maneuver of the vehicle at the location based on the vehicle information. The method also includes determining an intrusiveness of the maneuver made by the vehicle, and controlling traffic at the location based on the intrusiveness of the vehicle.

In accordance with another of the disclosure, a system for controlling traffic is provided. The system includes at least one communication module configured to transmit and receive information associated with vehicles navigating a location on a road network, and at least one processor in communication with the at least one communication module. The system also includes a memory comprising instructions executable by the processor, the instructions causing the at least one processor to receive, using the at least one communication module, vehicle information for a vehicle navigating the location, and identify a maneuver to be made by the vehicle at the location based on the vehicle information. The instructions further cause the processor to determine an intrusiveness of the maneuver made by the vehicle, and generate a report based on the intrusiveness of the vehicle.

In yet another aspect of the present disclosure, a non-transitory computer-readable medium is provided. The non-transitory computer-readable storage medium carries one or more sequences of one or more instructions which, when executed by one or more processors, cause a system to perform steps to receive vehicle information for a vehicle navigating a location on a road network, and identify a maneuver to be made by the vehicle at the location based on the vehicle information. The one or more sequences of one or more instructions also cause the system to perform steps to determine an intrusiveness of the maneuver made by the vehicle, and generate a report based on the intrusiveness of the vehicle.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The present invention will hereafter be described with reference to the accompanying figures, wherein like reference numerals denote like elements. The embodiments described are presented by way of example, and not by way of limitation, in the accompanying drawings:

FIG. 1 is a graphical illustration showing an example of a traffic scenario caused by large vehicle maneuvers;

FIG. 2 is a schematic diagram of an example system, in accordance with aspects of the present disclosure;

FIG. 3 is a schematic diagram an example controller for controlling traffic, in accordance with aspects of the present disclosure;

FIG. 4 is a flowchart setting forth steps of a process, in accordance with aspects of the present disclosure;

FIG. 5 is a diagram of an example geographic database, in accordance with aspects of the present disclosure;

FIG. 6 is a diagram of an example computer system, in accordance with aspects of the present disclosure;

FIG. 7 is a diagram of an example chip set, in accordance with aspects of the present disclosure; and

FIG. 8 is a diagram of an example mobile device, in accordance with aspects of the present disclosure.

### DETAILED DESCRIPTION

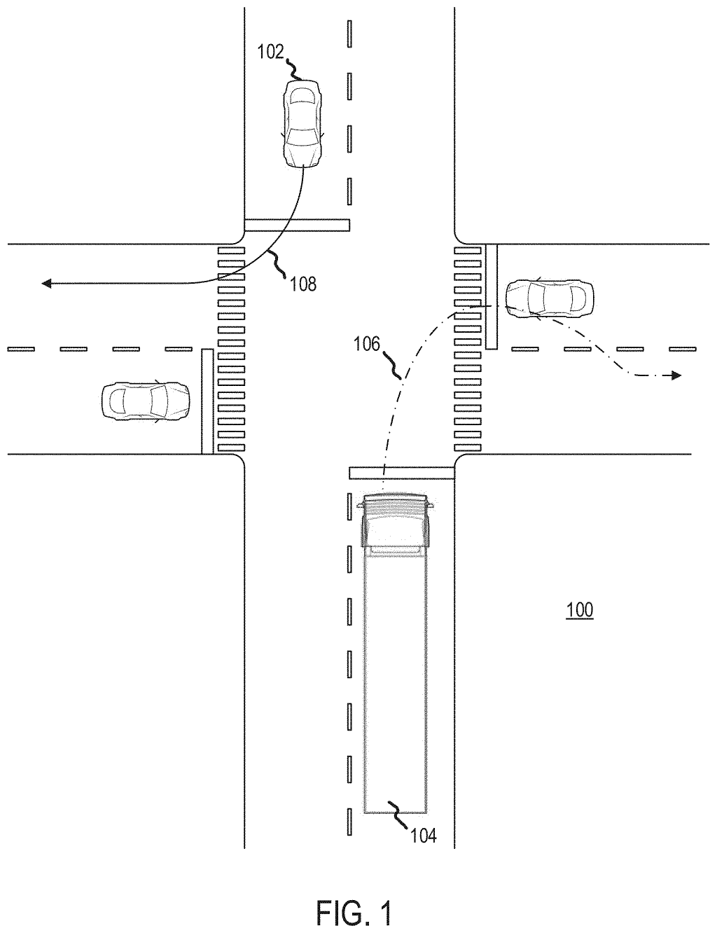

Traffic congestion occurs on roads for several reasons. For instance, there could be too many vehicles present at any one time, as well as too few mass-transportation options available for a given road network. Sudden reduction or closure of available traffic lanes, obstacles or accidents obstructing the lanes, inadequate traffic signal coordination or timing, pedestrians, and so forth also impede free flow of traffic. In particular, large vehicles (e.g., trucks, buses, vehicles with trailers, etc.) can produce significant traffic slow-downs or stops by attempting to navigate around tight roads, curves, building structures and so on. For example, as shown in FIG. 1, a small vehicle 102 making a turn in an intersection 100 would cause no traffic disruption, while a much larger vehicle 104 (e.g., semi-truck) may require a pathway 106 that is much wider, invading other lanes and potentially encountering on-coming traffic. Depending on the number of other vehicles and pedestrians present, the configuration of the road, weather conditions, time of day, as well as other factors, such intrusion can cause severe traffic disruption, gridlock and even accidents.

Conventional traffic systems typically monitor and provide alerts for traffic delays. Such systems, however, are typically reactive, and fail to anticipate potential traffic problems. In addition, vehicle traffic is often controlled by way of traffic lights, road paint, plaques and warning signs on the roadway (e.g., indicating speed limits, sharp turns, low clearances, weight limits, construction zones, and so on). However, such roadside control devices and indicators are typically positioned right at or slightly before the locations where the possible traffic issues occur, thereby providing insufficient advanced warning to drivers. Moreover, geometrical restrictions and traffic conditions often encourage drivers to ignore such indicators (e.g., intruding into other lanes), and thereby exacerbate the traffic problem. Accordingly, there is a need for improved techniques for controlling traffic.

The present disclosure provides a technical solution that addresses these challenges, as well as other shortcomings in the field. As described below, the present disclosure introduces novel systems and methods for controlling traffic. For instance, in accordance with some aspects of the present disclosure, traffic at a given location can be controlled by identifying the maneuver of a vehicle at the location, and determining an intrusiveness of the maneuver. In response to the intrusiveness, a number of vehicles and/or persons may be directed to control traffic.

As appreciated from description below, the present approach provides a number of advantages and improvements to traffic control technologies, as well as to mapping and navigation applications, products and services. For instance, unlike prior technologies, the present disclosure can provide mapping solutions that anticipate and include vehicle intrusiveness, which can be used to optimize navigation and routing, avoid unwanted traffic problems and minimize safety issues. In addition, the present approach provides important advantages for autonomous driving. For instance, systems and methods herein can be used to better predict the appropriate level of autonomous driving.

In the following description, and for the purposes of explanation, numerous specific details are set forth to provide a thorough understanding of the embodiments of the invention. It should be apparent to one skilled in the art, however, that the embodiments of the invention may be practiced with or without these specific details, or with equivalent arrangements. In other instances, well-known structures and devices are shown in block diagram form in order to avoid unnecessarily obscuring the embodiments of the invention.

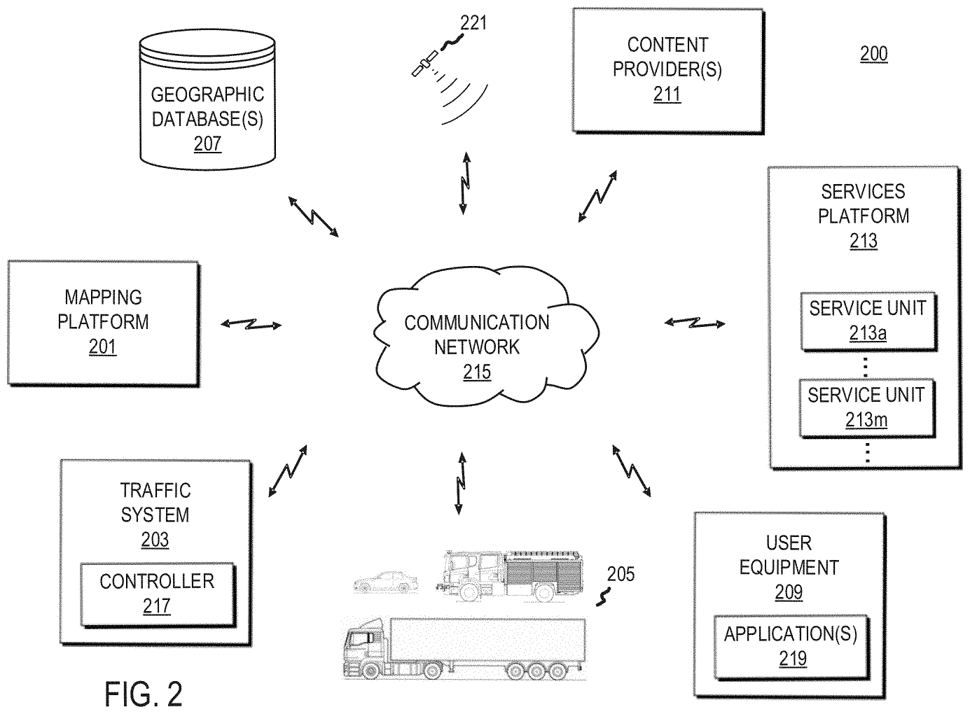

Referring particularly to FIG. 2, a schematic diagram of a system 200, in accordance with aspects of the present disclosure, is shown. In general, the system 200 include any device, apparatus, system, or a combination thereof, that is configured to carry out steps in accordance with the present disclosure. Specifically, the system 200 may include, be part of, or operate in collaboration with, various computers, systems, devices, machines, mainframes, networks, servers, databases, and so forth. In some embodiments, the system 200 may also include portable or mobile terminals or devices, such as cellular phones, smartphones, laptops, tablets, and the like. In this regard, the system 200 may be designed to integrate a variety of hardware, software, and firmware with various capabilities and functionalities. In addition, the system 200 may be capable of operating autonomously or semi-autonomously.

To carry out processing steps, in accordance with aspects of the present disclosure, the system 200, and the various systems, devices or components therein, may execute instructions or sequences of instructions stored in a non-transitory computer-readable medium (not shown in FIG. 2). The non-transitory computer-readable medium may be part of a memory, database, or other data storage location(s). To execute the instructions, the system 200 may include, and utilize a programmable processor, or combination of programmable processors. Alternatively, or additionally, the system 200 may also include and utilize one or more dedicated processors, or processing units, modules or systems specifically configured (e.g., hardwired, or programmed) to carry out steps, in accordance with methods described herein. In addition, the system 200 may further include, and/or share, a variety of interconnected components, including servers, intelligent networking/computing devices and other components, as well as corresponding software and/or firmware. By way of example, processing steps may be carried out using any combination of central processing units (CPUs), graphics processing units (GPUs), Digital Signal Processing (DSP) chips, Application Specific Integrated Circuits (ASICs), Field Programmable Gate Arrays (FPGAs), and so forth.

In some embodiments, the system 200 may include a mapping platform 201 configured to generate and process a variety of mapping information and data. The mapping platform 201 may also exchange information and data with a variety of other systems, devices, and hardware. For instance, as shown in FIG. 2, the mapping platform 201 may communicate with a traffic system 203, one or more vehicle(s) 205, geographic database(s) 207, user equipment (UE) 209, content provider(s) 211, and/or a services platform 313 by way of a communication network 215. Although the mapping platform 201 is depicted in the figure as a stand-alone system, it may be part of, or include various components, such as the traffic system 203, vehicle(s) 205, UE 209, services platform 213 or services 213a-m, or a combination thereof.

In some implementations, the mapping platform 201 may be configured to process data and information to detect certain objects or features depicted in images, and utilize various algorithms (e.g., machine learning algorithms) implemented using various computing architectures. To do so, the mapping platform 201 may utilize one or more neural networks configured to make predictions based on various machine learning models. For example, the mapping platform 201 may utilize a neural network, such as a convolutional neural network, with multiple layers and neurons. Also, the mapping platform 201 may utilize receptive fields of a collection of neuron(s) (e.g., a receptive layer) configured to correspond to the area of interest in inputted imagery or data.

The mapping platform 201 may also be configured to detect target features from imagery (e.g., top-down images, terrestrial images, and so forth), as well as identify various target points based on the features. The imagery can be obtained from a variety of different sources. For example, the imagery may be captured using aerial vehicles (e.g., airplanes, drones, and so forth), terrestrial vehicles (e.g., mapping vehicles, and the like), satellites, ground surveyors, device end-users, and using other equipment or methods. In some aspects, target features or target points can be marked or labeled in a large of set of training images. Labeling involves identifying pixels within a given image that correspond to the point or feature. Labeling may be performed automatically using various techniques, manually by a human labeler, a combination of both. The labeled training images may be used to train the machine learning algorithms to find the target points or features in new imagery (i.e., predicting the pixel locations associated with points or features in the input images). In addition to generating data (e.g., position data) corresponding to detected points or features, the mapping platform 201 may also be configured to generate confidence values/uncertainties for the data (e.g., confidence or uncertainty in position).

In some implementations, the machine learning algorithms utilized by the mapping platform 201 may be trained to automatically label imagery depicting areas to be mapped or analyzed. In addition, three-dimensional (3D) coordinates of target points or features can be estimated using multiple views, whereby corresponding points or features are labeled in two or more images (e.g., terrestrial, aerial, and so forth). To this end, the mapping platform 201 can determine pixel correspondences between various target points or features labeled in each of the images. The 3D coordinates can then be determined via a triangulation process from the pixel correspondences in combination with various camera information (e.g., model, position, pointing direction or pose, etc.) of the camera or camera system used to capture the images. Since different sources (e.g., satellites, airplanes, drones, etc.) often provide imagery of different quality and resolution, and uncertainty/error associated with the generated target points may also be computed.

As shown in FIG. 2, the system 200 may also include a traffic system 203. In some implementations, the traffic system 203 includes a controller 217 that is configured to control traffic, alone or in combination with the mapping platform 201 as well as other systems and devices. As described below, in some aspects, the controller 205 may identify an intrusiveness of one or more vehicles, and control traffic in response to the intrusiveness.

The traffic system 203 and/or mapping system 201 may have access to a geographic database 207. Specifically, the geographic database 207 may store various geographical data and information in a variety of forms and formats. For instance, the geographic database 207 may include road data (e.g. lane numbers, lane dimensions, pavement characteristics, and other road attributes), point of interest (POI) data, probe data, weather data, and so forth. The geographic database 207 may also include image data (e.g. terrestrial, aerial, etc.), drive data, and so forth.

In addition, the traffic system 203 and/or mapping system 201 may also communicate with various UE 209 and/or one or more vehicles 205. In one embodiment, the UE 209, or alternatively the vehicle(s) 205, may execute one or more applications 219 (e.g. software applications) configured to carry out steps in accordance with methods described here. For instance, in one non-limiting example, an application 219 may carry out steps for control traffic. In another non-limiting example, an application 219 may also be any type of application that is executable on the UE 209 and/or vehicle 205, such as autonomous driving applications, mapping applications, location-based service applications, navigation applications, content provisioning services, camera/imaging application, media player applications, social networking applications, calendar applications, and the like. In yet another non-limiting example, an application 219 may act as a client for the traffic system 203, and perform one or more functions associated with controlling traffic, either alone or in combination with the traffic system 203.

By way of example, the UE 209 may be, or include, an embedded system, mobile terminal, fixed terminal, or portable terminal including a built-in navigation system, a personal navigation or mobile device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 209 may support any type of interface with a user (e.g. by way of various buttons, touch screens, consoles, displays, speakers, “wearable” circuitry, and other I/O elements or devices). Although shown in FIG. 2 as being separate from the vehicle(s) 205, in some embodiments, the UE 209 may be integrated into, or part of, a vehicle 205.

In some embodiments, the UE 209 and/or vehicle(s) 205 may include various sensors for acquiring a variety of different data or information. For instance, the UE 209 and/or vehicle(s) 205 may include one or more camera/imaging devices for capturing imagery (e.g. terrestrial images), global positioning sensors (GPS) or Global Navigation Satellite System (GNSS) sensors for gathering location or coordinates data, network detection sensors for detecting wireless signals, receivers for carrying out different short-range communications (e.g., Bluetooth, Wi-Fi, Li-Fi, near field communication (NFC) etc.), temporal information sensors, audio recorders for gathering audio data, velocity sensors, switch sensors for determining whether one or more vehicle switches are engaged, and others.

The UE 209 and/or vehicle(s) 205 may also include light sensors, height sensors, accelerometers (e.g., for determining acceleration and vehicle orientation), tilt sensors (e.g. for detecting the degree of incline or decline), moisture sensors, pressure sensors, and so forth. Further, the UE 209 and/or vehicle(s) 205 may also include sensors for detecting the relative distance of a vehicle 205 from a lane or roadway, the presence of other vehicles, pedestrians, traffic lights, potholes and any other objects, or a combination thereof. Other sensors may also be configured to detect weather data, traffic information, or a combination thereof. Yet other sensors may also be configured to determine the status of various control elements of the car, such as activation of wipers, use of a brake pedal, use of an acceleration pedal, angle of the steering wheel, activation of hazard lights, activation of head lights, and so forth.

The UE 209 and/or vehicle(s) 205 may further include GPS, GNSS or other satellite-based receivers configured to obtain geographic coordinates from a satellite 221 (FIG. 2) for determining current location and time. Further, the location can be determined by visual odometry, SfM, triangulation systems such as A-GPS, Cell of Origin, or other location extrapolation technologies, and so forth.

In some implementations, the UE 209 and/or vehicle(s) 205 may include sensors configured to detect user activity (e.g., user movement, driver maneuvers, and so forth). In addition, the UE 209 and/or vehicle(s) 205 may include capabilities for providing recommendations or feedback based on the user activity, as well as other factors (e.g., location, traffic, etc.). For example, the UE 209 and/or vehicle(s) 205 may provide a recommendation or haptic feedback to help a driver navigate a maneuver. Such capabilities may also provide the ability to perform autonomous or semi-autonomous driving of the vehicle(s) 205.

Referring again to FIG. 2, the mapping platform 201 may also have connectivity with various content providers 211. Each content provider may send, or provide access to, various information or data to the mapping platform 201, traffic system 203, vehicle(s) 205, geographic database 207, UE 209, the services platform 213, and any combination thereof. The content provided may include map content (e.g., geographic data, parametric representations of mapped features, and so forth), textual content, audio content, video or image content, and so forth. In some implementations, the content providers 211 may send, or provide access to, information or data for controlling traffic. In some implementations, the content providers 211 may also receive and store content from the mapping platform 201, traffic system 203, vehicle(s) 205, geographic database 207, UE 209, services platform 213, and any combination thereof. The content providers 211 may also manage access to a central repository of data, and offer a consistent, standard interface to data, such as a repository of the geographic database 207.

As shown in FIG. 2, the mapping platform 201 may further connect over the communication network 215 to the services platform 213 (e.g., a third-party platform), which may include one or more service units 213a-m providing one or more services. By way of example, the services platform 213 may provide mapping services, navigation services, travel planning services, notification services, social networking services, content (e.g., audio, video, images, etc.) provisioning services, application services, storage services, contextual information determination services, location-based services, information-based services (e.g., weather, news, etc.), and so forth. In one embodiment, the services platform 213 may assist in localizing a vehicle 205 or UE 209 (e.g., a portable navigation device, smartphone, portable computer, tablet, etc.), as well as other objects in a scenery, and provide services such as navigation, mapping, advertisement, other location-based services, and so forth.

The communication network 215 may include any number of networks, such as data networks, wireless networks, telephony networks, or combinations thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The mapping platform 201, traffic system 203, vehicle(s) 205, geographic database 207, UE 209, content provider 211, and services platform 213 may communicate with each other, and other components of the system 200, using various communication protocols. By way of example, protocols may include a set of rules defining how the network nodes within the communication network 215 interact with each other based on information and data sent over the communication links. The protocols may be effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information and data over a network are described in the Open Systems Interconnection (OSI) Reference Model.

Communications between the network nodes may be carried out by exchanging discrete packets of data. Each packet may comprise (1) header information associated with a particular protocol, and (2) payload information that follows the header information and contains information that may be processed independently of that particular protocol. In some protocols, the packet may include (3) trailer information following the payload and indicating the end of the payload information. The header may include information such as the source of the packet, its destination, the length of the payload, and other properties used by the protocol. The data in the payload for the particular protocol may include a header and payload for a different protocol associated with a different, higher layer of the OSI Reference Model. The header for a particular protocol may indicate a type for the next protocol contained in its payload. The higher layer protocol may be encapsulated in the lower layer protocol. The headers included in a packet traversing multiple heterogeneous networks, such as the Internet, may include a physical (layer 1) header, a data-link (layer 2) header, an internetwork (layer 3) header and a transport (layer 4) header, and various application (layer 5, layer 6 and layer 7) headers as defined by the OSI Reference Model.

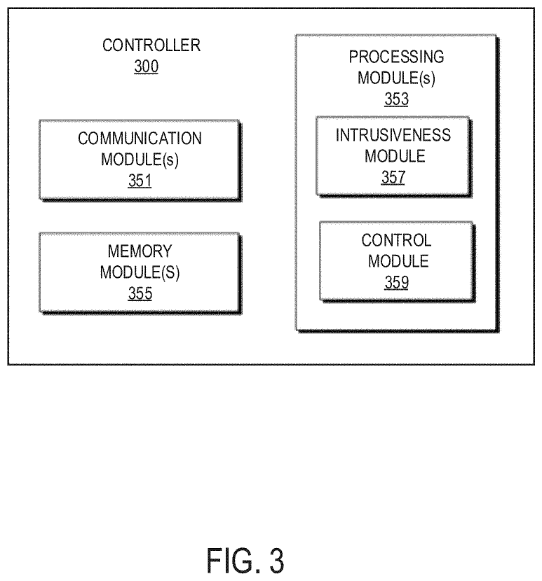

Referring now to FIG. 3, a schematic diagram of an example controller 300, for use in accordance with aspects of the present disclosure, is illustrated. As shown, in some embodiments, the controller 300 may include a number of communication modules 351, one or more processing modules 353, one or more memory modules 355, and possibly others. The modules can be implemented using various hardware, firmware, software, as described with reference to the system 200 of FIG. 2. Alternatively, or additionally, modules may also be implemented as a cloud-based service, local service, native application, or combination thereof. Although the modules in FIG. 3 are shown to be separate components of the controller 300, it is contemplated that their respective functions may be readily combined into fewer modules, or further separated into more specialized modules.

The communication module(s) 351 may include any combination of input and output elements for receiving and relaying various data and information. Example input elements may include a mouse, keyboard, touchpad, touchscreen, buttons, and other user interfaces configured for receiving various selections, indications, and operational instructions from a user. Input elements may also include various drives and receptacles, such as flash-drives, USB drives, CD/DVD drives, and other computer-readable medium receptacles, for receiving various data and information. Example output elements may include displays, touchscreens, speakers, LCDs, LEDs, and so on. In addition, I/O modules 351 may also include various communication hardware configured for exchanging data and information with various external computers, systems, devices, machines, mainframes, servers or networks, for instance.

In some embodiments, the processing module(s) 353 include an intrusiveness module 357 and a control module 359. The intrusiveness module 357 may be configured to execute instructions and determine an intrusiveness of one or more vehicles navigating a location on a road network, in accordance with aspects of the present disclosure. The vehicles may be present at the location, driving toward the location, or within a pre-determined distance from the location. The vehicles may be operated manually, autonomously, or semi-autonomously. To this end, the intrusiveness module 357 may receive a variety of information, including vehicle information (e.g., vehicle type or class, vehicle properties, vehicle origin, vehicle destination, vehicle position, vehicle orientation, vehicle heading, vehicle speed, and so forth), geographic or road information (e.g., lane configuration, lane dimensions, road geometry or curvature, road attributes, etc.), location information (e.g., POIs etc.), probe information (e.g., GPS, etc.), as well as other information. Using the received information, the intrusiveness module 357 may identify a maneuver to be made by the vehicle at the location and determine the intrusiveness of the maneuver. As described herein, the maneuver of a vehicle may include one or more movements made by the vehicle, as well as movements by any extensions or attachments of the vehicle (e.g., trailers, campers, boats, heavy equipment, ladders, etc.). Non-limiting examples of movement include left turns, right turns, U-turns, forward movement, backward movement, leftward movement, rightward movement, and so on. The intrusiveness may be determined by intrusiveness module 357 periodically or in substantially real-time.

In some aspects, the location(s) where intrusiveness is determined may be previously identified or predetermined (e.g., based on the destination of the vehicle, a location where traffic needs to be controlled, etc.). Alternatively, the location(s) may be identified, by the intrusiveness module 357 or another module, system, or device, based on specific criteria. For instance, the location may be selected based on where a vehicle encounters a turn or a sharp curve, or where the vehicle deviates from a linear path by a predetermined amount. To this end, the intrusiveness module 357, or other module, system or device, may analyze the route taken by a vehicle between its origin and destination and identify movements that satisfy the specific criteria. The location(s) where the movement(s) satisfy the criteria would then be selected. Once the location is identified or selected, the intrusiveness module 357 may then determine the maneuver carried out by the vehicle at the location.

The intrusiveness module 357 may also estimate a pathway taken by a vehicle when carrying out the maneuver at the predetermined or selected location. To do so, the intrusiveness module 357 may use various information, such as vehicle information and road information. For example, the intrusiveness module 357 may use a vehicle class, or vehicle size, and road geometry to compute the pathway. In some aspects, the pathway may be optimized to minimize collisions with persons, vehicles or objects on the roadway. As such, other data may be utilized, such as other vehicle data, location data, probe data, and so forth.

In some aspects, the intrusiveness module 357 may compute an intrusiveness score that quantifies the intrusiveness of a vehicle at the location. The intrusiveness score may be computed using several variables, such as the number of vehicles at the location, the number of persons at the location, the pathway of the maneuver, the duration of the maneuver, the number of lanes (e.g., open or blocked), the number of obstructions (e.g., dividers), the time of day of the maneuver, weather conditions, and so forth. The intrusiveness score may also be based on or more delays to different vehicles or pedestrians. In addition, a total delay, that sums delays to all vehicles and pedestrians present at or inbound toward the location, may also be computed and considered in the intrusiveness score. In one non-limiting example, a high number of vehicles or long delays at the location would likely affect more people, and therefore correspond to a higher intrusiveness and score. In another non-limiting example, a pathway of the vehicle that extends into an oncoming lane or traffic may correspond to a higher intrusiveness and score. Such extension can be quantified, for instance, by the length of the pathway that deviates from the vehicle's traffic lane, or by an area that the pathway spans in an oncoming lane of traffic.

Any of the above-listed variables, in any combination, may be used to compute the intrusiveness score, and may be weighed equally or unequally in the computation. In some aspects, the intrusiveness module 357 may compute an intrusiveness score for multiple vehicles navigating a particular location. A such, an aggregate intrusiveness score may also be computed for the location by adding individual intrusiveness scores from multiple vehicles.

The intrusiveness module 357 may then generate a report. The report may be in any form, and provide various information. In some implementations, the report may include visual and/or audio signals, images, tabulated information, data, instructions (user-readable or machine-readable), and various combinations thereof. For instance, the report may also include data pertinent to intrusiveness (e.g., intrusiveness scores, variables, etc.), timestamps, uncertainties and so forth, assembled as graphs, images, tables, trajectories, numbers, text, and other representations. The report may be communicated to a user or operator by way of a display, speakers, or other means of output, as well as to various devices or systems for further steps, analysis, or processing. In some aspects, the report may be provided in real-time (e.g., substantially as data is being captured) via communication module(s) 351 to a user, or an external device, apparatus or system. The report may also be stored in the memory module(s) 355 for later access or retrieval, as well as stored elsewhere (e.g., a database, a server, etc.).

In some aspects, information from the report, such as individual or aggregate intrusiveness scores, may be assembled in the form of a map layer or map attribute, for example. In other aspects, the report may be configured to direct one or more vehicles and/or persons in response to the intrusiveness. As such, the report may be additionally or alternatively provided to the control module 359. In general, the control module 359 may be configured to control traffic at one or more identified or selected locations in a variety of ways. For instance, the control module 359 may be configured to communicate and direct the operation of electronic traffic control devices, such as traffic signals. The control module 359 may also be configured to communicate and direct various devices and systems (e.g., navigation systems, personal or mobile devices, and so forth). The control module 359 may further be configured to communicate with various using sensors positioned about a location or roadway (e.g., cameras, infrared sensors, microwave sensors, etc.) and configured to capture data for use in controlling traffic.

In some implementations, the control module 359 may be configured to control traffic in response to intrusiveness at selected or pre-determined locations. In particular, the control module 359 may direct one or more vehicles and/or persons in a manner that minimizes a number of intrusiveness scores or aggregate scores, or reduces any of these below a predetermined threshold. For instance, in some aspects, the control module 359 may provide information or instructions for navigation. To this end, the control module 359 may communicate with a navigation system of a vehicle, which upon information or instructions generated by the control module 359, would provide an alternative route, delay a maneuver, or indicate more desirable travel times or weather conditions. The control module 359 may also assist the driver by providing guidance for carrying out a maneuver. For example, the control module 359 may provide lane guidance. Such guidance may be given through audio or visual instructions or information, as well as through haptic feedback (e.g., through the steering wheel). In this manner, a vehicle that is turning too shallow or wide and intrudes into oncoming traffic way, for instance, can get immediate feedback and direction. To this end, the control module 359 may generate a desirable pathway for the vehicle.

The control module 359 may further control autonomous or semi-autonomous vehicles. For instance, the control module 359 may control the route or pathway taken by an autonomous vehicle, as well as other features associated with the vehicle. Also, in some implementations, the control module 359 may trigger autonomous or non-autonomous driving mode at particular locations. To do so, the control module 359 may use map attributes and information, (e.g., intersection type, slope, curvature etc.) corresponding to a location, and evaluate the difficulty or intrusiveness of a maneuver. Based on the difficulty, the control module 359 may control the mode or level of autonomous driving. For instance, if the difficulty or intrusiveness is above a certain threshold, the control module 359 could trigger or suggest a specific mode of driving (e.g., autonomous driving). In triggering the mode of driving, other information may be utilized, including whether the location supports autonomous or non-autonomous driving. In some aspects, a remote monitoring could also be triggered by the control module 359 when the autonomous vehicle is approaching an area of high intrusiveness score (e.g., above a threshold). Remote monitoring could provide access to sensors of the vehicle, as well as allow control of some key vehicle functions, as needed. In addition, the control module 359 may take other actions, including deploying vehicles (e.g., aerial vehicles, autonomous vehicles, etc.) to monitor a given location, and provide alerts. Moreover, the control module 359 may direct vehicles incident upon the location to avoid or delay arrival at the location. The control module 359 may do so by providing alerts or instructions, as well as by blocking one or more roads or intersections on route (e.g., by deploying aerial, autonomous vehicles, or via traffic control devices etc.). In some aspects, the control module 359 may alert the driver or passengers of a maneuvering vehicle as to an upcoming a difficult maneuver. In vehicles with such capabilities, the control module 359 may also modify the position of vehicle occupants (e.g., by moving/orienting their seats) to increase visibility and safety.

In providing guidance or controlling vehicle operation, machine learning algorithms may be used to generate directions to carry out vehicle maneuvers. Such algorithms may be trained using historical data. For example, a machine learning algorithm may be trained using data corresponding to successful and unsuccessful maneuvers. The success of a maneuver may be quantified or determined in a number of ways. For instance, a maneuver may be deemed successful if a computed intrusiveness score corresponding to the maneuver is below a threshold. Other maneuver success indicators may also be used, such as the (in)ability of a vehicle to cross a given area without causing an accident or damage to vehicles, buildings, or infrastructure, for example. In some implementations, training the algorithm involves capturing data associated with variables used to compute an intrusiveness score (e.g., number of vehicles at the location, number of persons at the location, pathway of the maneuver, duration of the maneuver, number of lanes, number of obstructions, time of day, weather conditions, and so forth). The data may then be used ground truth to train the machine learning model to provide directions for successful maneuvers.

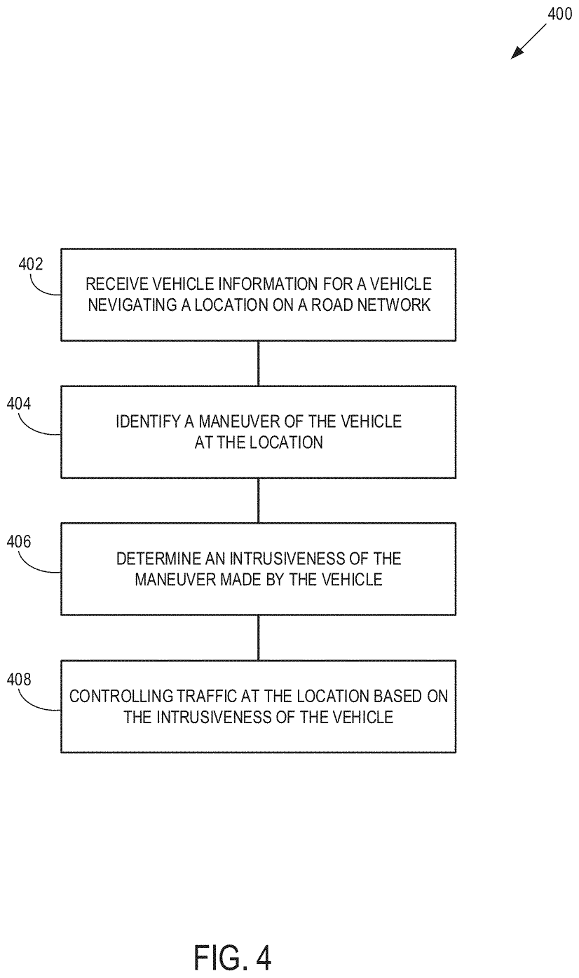

Turning now to FIG. 4, a flowchart setting forth steps of a process 400, in accordance with aspects of the present disclosure, is illustrated. Steps of the process 400 may be carried out using any combination of suitable devices or systems, as well as using systems described in the present disclosure. In some embodiments, steps of the process 400 may be implemented as instructions stored in non-transitory computer readable media, as a program, firmware or software, and executed by a general-purpose, programmed or programmable computer, processer or other computing device. In other embodiments, steps of the process 400 may be hardwired in an application-specific computer, processer, dedicated system, or module, as described with reference to FIGS. 2 and 3. Although the process 400 is illustrated and described as a sequence of steps, it is contemplated that the steps may be performed in any order or combination, and need not include all of the illustrated steps.

The process 400 may begin at process block 402 with receiving or accessing vehicle information for a vehicle navigation a location on a road network. As described, vehicle information may include vehicle type or class, vehicle properties, vehicle origin, vehicle destination, vehicle position, vehicle orientation, vehicle heading, vehicle speed, and so forth. The vehicle information may be accessed from a database, memory or server, as well as from another storage location (e.g., a vehicle system, device or memory). Other information may also be accessed at process block 402, such as road information (e.g., lane configuration, lane dimensions, road geometry or curvature, road attributes, etc.), location information (e.g., POIs etc.), probe information (e.g., GPS, etc.).

Based on the vehicle information, a maneuver of the vehicle at the location may be identified at process block 404. This may include determining one or more movements made by the vehicle, as well as movements by any extensions or attachments of the vehicle. Such movements may include left turns, right turns, U-turns, forward movement, backward movement, leftward movement, rightward movement, and so on. As described, the location may be predetermined, or identified by analyzing the route taken by the vehicle between its origin and destination, and selecting a location where its movements satisfy specific criteria. In some aspects, a pathway corresponding to the maneuver of the vehicle at the location may be estimated by using the vehicle information and road information.

An intrusiveness of the maneuver made by the vehicle at the location may then be determined at process block 406. In some aspects, an intrusiveness score associated with the maneuver may be computed using a combination of different variables, such as the number of persons at the location, the pathway of the maneuver, the duration of the maneuver, the number of lanes, the number of obstructions, the time of day of the maneuver, weather conditions, delays and so forth.

Then, traffic may be controlled at the location based on the intrusiveness of the vehicle, as indicated by process block 408. As described, traffic at the location may be controlled in any number of ways. For instance, alerts, directions, or guidance may be provided to the vehicle, as well as to other vehicles and pedestrians. In some aspects, directions to vehicles and/or persons may be configured to minimize a number of intrusiveness scores or aggregate scores, or to reduce any of these below a predetermined threshold.

In some aspects, a report may be generated at process block 408. The report may be in any form, and provide various information. In some implementations, the report may be in the form of visual and/or audio signals, images, tabulated information and data, instructions, and combinations thereof. As described, the report may be communicated to a user or operator by way of a display, speakers, or other means of output, as well as to various devices or systems for further steps, analysis or processing. For example, as described, the report may provide information or instructions for navigation and guidance, which when processed or executed by an appropriate system, apparatus or device, would provide an alternative route, delay a maneuver, indicate desirable travel times or weather conditions, provide desired pathway, give haptic feedback, and so forth. In some aspects, the report may be provided in real-time (e.g., substantially as data is being captured). The report, and various data and information therein, may also be stored (e.g., in a memory, a database, a server, and so forth). In some aspects, the report may be directed to a mapping platform (e.g. as described with reference to FIG. 2), which in turn may use the report to generate mapping data and information (e.g. to generate an intrusiveness map layer or map attribute using intrusiveness scores).

Process blocks 402-408 may be performed periodically, intermittently, or as prompted by a user, device, apparatus, or system. Moreover, process blocks 402-408 may be carried out with respect to multiple vehicles, as well as multiple locations.

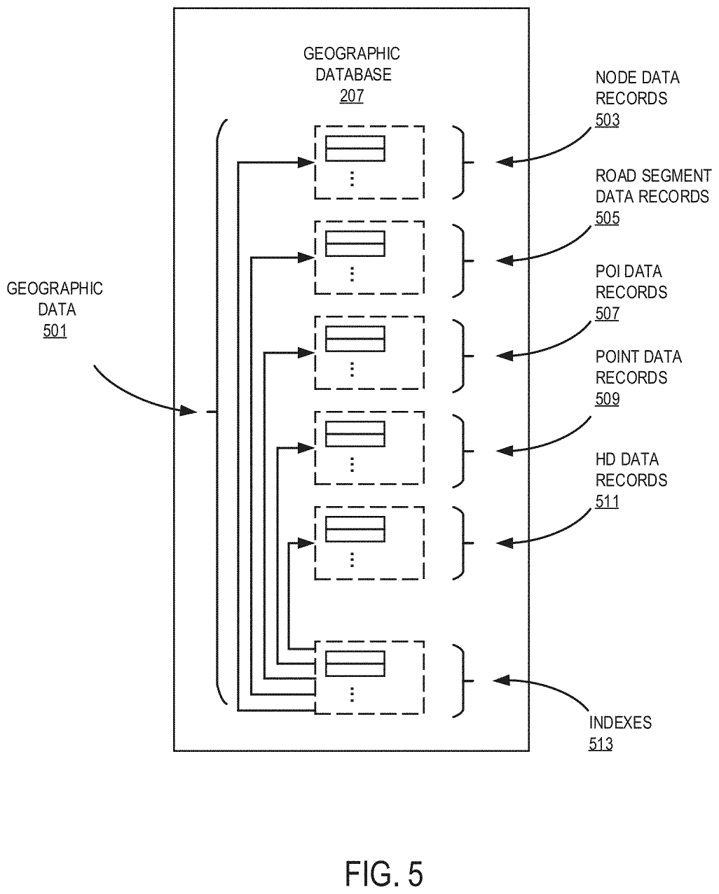

Turning now to FIG. 5, a diagram of a geographic database 207, according to aspects of the present disclosure, is shown. As shown, the geographic database 207 may include a variety of geographic data 501 tabulated in various arrangements, and used in various applications. For example, the geographic data 501 may be used for (or configured to be compiled to be used for) mapping and/or navigation-related services. As shown in FIG. 5, the geographic data 501 may include node data records 503, road segment data records 505, point of interest (POI) data records 507, point data records 509, high definition (HD) mapping data records 511, and indexes 513, for example. The geographic data 501 may include more, fewer, or different data records. In some embodiments, additional data records (not shown in FIG. 5) may also be included, such as cartographic (“carto”) data records, routing data records, maneuver data records, and other data records.

In particular, the HD mapping data records 511 may include a variety of data, including data with resolution sufficient to provide centimeter-level or better accuracy of map features. For example, the HD mapping data may include data captured using LiDAR, or equivalent technology capable large numbers of 3D points, and modelling road surfaces and other map features down to the number lanes and their widths. In one embodiment, the HD mapping data (e.g., HD data records 511) capture and store details such as the slope and curvature of the road, lane markings, roadside objects such as signposts, including what the signage denotes. By way of example, the HD mapping data enable highly automated vehicles to precisely localize themselves on the road.

In some implementations, geographic features (e.g., one-dimensions, two-dimensional, or three-dimensional features) may be represented in the geographic database 207 using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building.

In some implementations, certain conventions or rules may be followed in the geographic database 207. For example, links may not cross themselves or each other except at a node. In another example, shape points, nodes, or links may not be duplicated. In yet another example, two links that connect each other may have a common node. In the geographic database 207, overlapping geographic features are represented by overlapping polygons. When polygons overlap, the boundary of one polygon crosses the boundary of the other polygon.

In the geographic database 207, the location at which the boundary of one polygon intersects the boundary of another polygon may be represented by a node. In one embodiment, a node may be used to represent other locations along the boundary of a polygon than a location at which the boundary of the polygon intersects the boundary of another polygon. In one embodiment, a shape point may not be used to represent a point at which the boundary of a polygon intersects the boundary of another polygon.

In exemplary embodiments, the road segment data records 505 may be links or segments representing roads, streets, or pathways, and can be used in the calculated route or recorded route information for determination of one or more personalized routes. The node data records 503 may be end points corresponding to the respective links or segments of the road segment data records 505. The road link data records 505 and the node data records 503 may represent a road network, as used by vehicles, cars, and/or other entities, for instance. Alternatively, the geographic database 207 may contain pathway segment and node data records or other data that represent pedestrian pathways or areas in addition to or instead of the vehicle road record data, for example.

The road/link segments and nodes can be associated with attributes, such as functional class, a road elevation, a speed category, a presence or absence of road features, geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 207 can include data about the POIs and their respective locations in the POI data records 507. The geographic database 207 can also include data about places, such as cities, towns, or other communities, and other geographic features, such as bodies of water, mountain ranges, etc. Such place or feature data can be part of the POI data records 507 or can be associated with POIs or POI data records 507 (such as a data point used for displaying or representing a position of a city).

As shown in FIG. 5, the geographic database 207 may also include point data records 509 for storing the point data, map features, as well as other related data used according to the various embodiments described herein. In addition, the point data records 509 can also store ground truth training and evaluation data, machine learning models, annotated observations, and/or any other data. By way of example, the point data records 509 can be associated with one or more of the node records 503, road segment records 505, and/or POI data records 507 to support verification, localization or visual odometry based on the features stored therein and the corresponding estimated quality of the features. In this way, the records 509 can also be associated with or used to classify the characteristics or metadata of the corresponding records 503, 505, and/or 507.

As discussed above, the HD mapping data records 511 may models of road surfaces and other map features to centimeter-level or better accuracy. The HD mapping data records 511 may also include models that provide the precise lane geometry with lane boundaries, as well as rich attributes of the lane models. These rich attributes may include, but are not limited to, lane traversal information, lane types, lane marking types, lane level speed limit information, and/or the like. In one embodiment, the HD mapping data records 511 may be divided into spatial partitions of varying sizes to provide HD mapping data to vehicles and other end user devices with near real-time speed without overloading the available resources of these vehicles and devices (e.g., computational, memory, bandwidth, etc., resources). In some implementations, the HD mapping data records 511 may be created from high-resolution 3D mesh or point-cloud data generated, for instance, from LiDAR-equipped vehicles. The 3D mesh or point-cloud data may be processed to create 3D representations of a street or geographic environment at centimeter-level accuracy for storage in the HD mapping data records 511.

In one embodiment, the HD mapping data records 511 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

The geographic database 207 may be maintained by content provider in association with a services platform (e.g., a map developer), as described with reference to FIG. 2. The map developer can collect geographic data to generate and enhance the geographic database 207. The data may be collected in various ways by the map developer, including obtaining data from other sources, such as municipalities or respective geographic authorities. In addition, the map developer can employ field personnel to travel by vehicle along roads throughout the geographic area of interest to observe features and/or record information about them, for example. Also, remote sensing, such as aerial or satellite photography, can be used.

In some implementations, the geographic database 207 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device of a vehicle, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The indexes 513 in FIG. 5 may be used improve the speed of data retrieval operations in the geographic database 207. Specifically, the indexes 513 may be used to quickly locate data without having to search every row in the geographic database 207 every time it is accessed. For example, in one embodiment, the indexes 513 can be a spatial index of the polygon points associated with stored feature polygons.

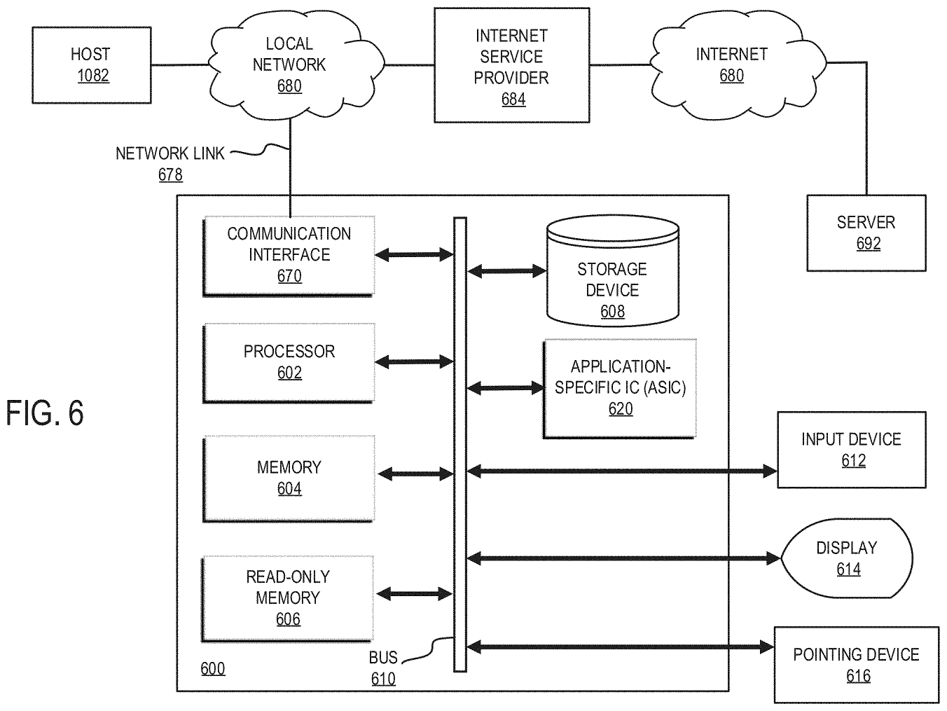

Turning now to FIG. 6, an example computer system 600, in accordance with aspects of the present disclosure, is illustrated in FIG. 6. The computer system 600 may be programmed (e.g., via computer program code or instructions) to perform a variety of steps, including steps for controlling traffic, in accordance with methods described herein.

As shown in FIG. 6, the computer system 600 may generally include a processor 602, which may be configured to perform a set of operations on information as specified by computer program code. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). In some aspects, the set of operations may include bringing information in from a bus 610 and placing information on the bus 610. The set of operations may also include comparing two or more units of information, shifting positions of units of information, and combining two or more units of information, such as by addition or multiplication or logical operations like OR, exclusive OR (XOR), and AND. Each operation of the set of operations performed by the processor 602 may be represented to the processor 602 by information called instructions, such as an operation code of one or more digits. The sequence of operations to be executed by the processor 602, such as a sequence of operation codes, constitute processor 602 instructions, may also be called computer system 600 instructions or, simply, computer instructions. The processor 602 may include multiple processors, units or modules, and may be implemented as mechanical, electrical, magnetic, optical, chemical or quantum components, among others, or any combination thereof.

As shown in FIG. 6, the computer system 600 may also include a memory 604 coupled to bus 610. The memory 604, such as a random-access memory (RAM) or other dynamic storage device, may be configured to store a variety of information and data, including processor instructions for carrying steps in accordance with aspects of the disclosure. Dynamic memory allows information stored therein to be changed by the computer system 600. The RAM allows a unit of information stored at a location called a memory address to be stored and retrieved independently of information at neighboring addresses. The memory 604 may also be used by the processor 602 to store temporary values during execution of processor instructions.

The computer system 600 may also include a read-only memory (ROM) 606, or other static storage device, coupled to the bus 610. The ROM 606 may be configured for storing static information, including instructions, that is not changed by the computer system 600. Some memory 604 includes volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

As mentioned, the bus 610 may be configured for passing information and data between internal and external components of the computer system 600. To do so, the bus 610 may include one or more parallel conductors that facilitate quick transfer of information and data among the components coupled to the bus 610. The information and data may be represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, may represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, analog data may be represented by a near continuum of measurable values within a particular range.

Information, data, and instructions for controlling traffic may be provided to the bus 610 for use by the processor 602 from an external input device 612, such as a keyboard or other sensor. The sensor may be configured to detect conditions in its vicinity and transform those detections into physical expression compatible with the measurable phenomenon used to represent information in computer system 600. Other external devices coupled to bus 610, used primarily for interacting with humans, may include a display device 614, such as a cathode ray tube (CRT) or a liquid crystal display (LCD), or plasma screen or printer for presenting text or images, as well as a pointing device 616 (e.g., a mouse, trackball, cursor direction keys, motion sensor, etc.) for controlling a position of a small cursor image presented on the display 614 and issuing commands associated with graphical elements presented on the display 614. In some embodiments, for example, the computer system 600 performs all functions automatically without human input. As such, one or more of external input device 612, display device 614 and pointing device 616 may be omitted.

As shown in FIG. 6, special purpose hardware, such as an application specific integrated circuit (ASIC) 620, may be coupled to bus 610. The special purpose hardware may be configured to perform specialized operations. Examples of ASICs include graphics accelerator cards for generating images for display 614, cryptographic boards for encrypting and decrypting messages sent over a network, speech recognition, and interfaces to special external devices.

The computer system 600 may also include one or more instances of a communications interface 670 coupled to bus 610. The communication interface 670 may provide a one-way or two-way communication coupling to a variety of external devices that operate with their own processors, such as printers, scanners, and external disks. In addition, the communication interface 670 may provide a coupling to a local network 680, by way of a network link 678. The local network 680 may provide access to a variety of external devices and systems, each having their own processors and other hardware. For example, the local network 680 may provide access to a host 682, or an internet service provider 684, or both, as shown in FIG. 6. The internet service provider 684 may then provide access to the internet 690, in communication with various other servers 692.

By way of example, the communication interface 670 may include a parallel port or a serial port or a universal serial bus (USB) port on a personal computer. In some embodiments, the communications interface 670 may include one or more integrated services digital network (ISDN) cards, or digital subscriber line (DSL) cards, or telephone modems that provides an information communication connection to a corresponding type of telephone line. In some embodiments, the communication interface 670 may include a cable modem that converts signals on bus 610 into signals for a communication connection over a coaxial cable or into optical signals for a communication connection over a fiber optic cable. As another example, the communications interface 670 may be a local area network (LAN) card configured to provide a data communication connection to a compatible LAN, such as Ethernet. Wireless links may also be implemented. For wireless links, the communications interface 670 may send and/or receive electrical, acoustic or electromagnetic signals, including infrared and optical signals, that carry information streams, including digital data. For example, in wireless handheld devices (e.g., mobile telephones, cell phones, and so forth), the communications interface 670 may include a radio band electromagnetic transmitter and receiver called a radio transceiver. In certain embodiments, the communications interface 670 enables connection to the communication network, as described with reference to FIG. 2.

As used herein, computer-readable media refers to any media that participates in providing information to processor 602, including instructions for execution. Such media may take many forms, and include non-volatile media, volatile media, transmission media, and others. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

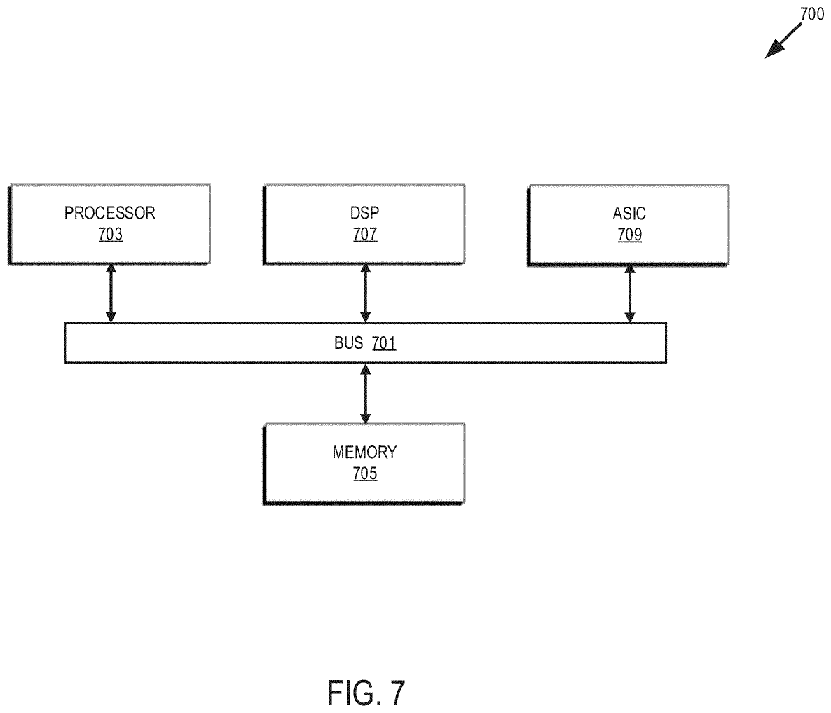

Turning now to FIG. 7, a chip set 700, in accordance with aspects of the present disclosure, is illustrated. In some implementations, the chip set 700 may be programmed to carry out steps in accordance with methods described herein, and may include various components (e.g., as described with respect to FIG. 6) incorporated in one or more physical packages (e.g., chips). By way of example, a physical package includes an arrangement of one or more materials, components, and/or wires on a structural assembly (e.g., a baseboard) that provides one or more characteristics, such as physical strength, conservation of size, and/or limitation of electrical interaction. It is contemplated that in certain embodiments the chip set 700 can be implemented in a single chip.

As shown, the chip set 700 may include a communication mechanism, such as a bus 701 for passing information and data among the components of the chip set 700. A processor 703 connected to the bus 701 may be configured to execute instructions and process information stored in, for example, a memory 705. The processor 703 may include one or more processing cores, with each core capable of performing independently. In some implementations, a multi-core processor may be used, which enables multiprocessing within a single physical package. Examples of a multi-core processor include two, four, eight, or greater numbers of processing cores. Alternatively, or additionally, the processor 703 may include one or more microprocessors configured in tandem, via the bus 701, to perform independent execution of instructions, pipelining, and multithreading.

The chip set 700 may also include specialized components configured to perform certain processing functions and tasks. For instance, the chip set 700 may include one or more digital signal processors (DSP) 707, or one or more application-specific integrated circuits (ASIC) 709, or both. In particular, the DSP 707 may be configured to process real-world signals (e.g., sound) in real time independently of the processor 703. Similarly, the ASIC 709 may be configured to performed specialized functions not easily performed by a general-purpose processor. Other specialized components to aid in performing the inventive functions described herein may include one or more field programmable gate arrays (FPGA) (not shown), one or more controllers (not shown), or one or more other special-purpose computer chips.

The processor 703 and accompanying components may have connectivity to the memory 705 via the bus 701, as shown. The memory 705 may include dynamic memory (e.g., RAM, magnetic disk, writable optical disk, etc.), static memory (e.g., ROM, CD-ROM, etc.), and others, configured for storing executable instructions. The instructions, when executed, perform a variety of steps, including steps for identifying the quality of terrestrial data, in accordance with methods described herein. The memory 705 may also store the data associated with or generated by the execution.

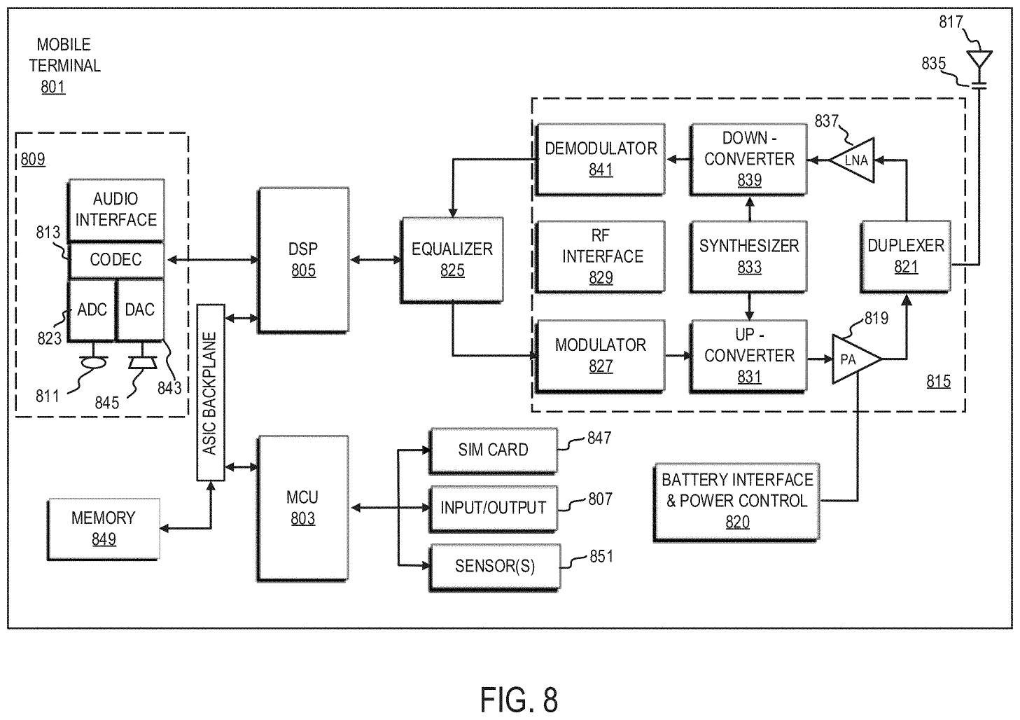

Turning now to FIG. 8, a diagram of example mobile device 801, in accordance with aspects of the present disclosure, is shown. In some implementations, the mobile device 801 may be a handhold cellular phone, smart phone, tablet, and so forth. Alternatively, the mobile device 801 may be an embedded component of the vehicle 305 or UE 309, as described with reference to FIG. 3.

In general, the mobile device 801 may include a Main Control Unit (MCU) 803, a Digital Signal Processor (DSP) 805, a number of input/output components 807. In some configurations, input/output components 807 (e.g., a display, touchscreen, keyboard, etc.) are configured to provide feedback to user in support of various applications and functions of the mobile device 801. The mobile device 801 may also include audio function circuitry 809, including a microphone 811 and microphone amplifier that amplifies the sound signal output from the microphone 811. The amplified sound signal output from the microphone 811 is fed to a coder/decoder (CODEC) 813. In some embodiments, the audio function circuitry 809 may include a receiver/transmitter unit including a microphone gain control unit and a speaker gain control unit.

The mobile device 801 may also include a radio section 815, which amplifies power and converts frequency in order to communicate with a base station, which is included in a mobile communication system, via antenna 817. Generally, a radio receiver is often defined in terms of front-end and back-end characteristics. The front-end of the receiver encompasses all of the Radio Frequency (RF) circuitry whereas the back-end encompasses all of the base-band processing circuitry. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The MCU 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

As shown in FIG. 8, the MCU 803 is in communication with various input/output components 807 may be configured to receive various signals therefrom and send signals thereto. The MCU 803, input/output components 807, in combination with other user input components (e.g., the microphone 811), comprise a user interface circuitry for managing user input. The MCU 803 may run a user interface software to facilitate user control of at least some functions of the mobile station 801. The MCU 803 may also deliver a display command and a switch command to the input/output components 807 and to the speech output switching controller, respectively. Further, the MCU 803 may exchange information with the DSP 805 and can access an optionally incorporated SIM card 847 and a memory 849. In addition, the MCU 803 may execute various control functions required. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 may include the ADC 823 and DAC 843. The memory 849 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory 851 may be, but not is limited to, a single memory, CD, DVD, ROM, RAM, EEPROM, optical storage, or any other non-volatile or non-transitory storage medium capable of storing digital data.

An optionally incorporated SIM card 847 may carry, for instance, important information, such as the cellular phone number, the carrier supplying service, subscription details, and security information. The SIM card 847 serves primarily to identify the mobile station 801 on a radio network. The SIM card 847 also contains a memory for storing a personal telephone number registry, text messages, and user specific mobile station settings.

In some embodiments, the mobile device 801 may also include a number of sensors 851. For instance, the mobile device 801 may include one or more image sensors (e.g., camera(s), position sensors (e.g., GNSS or GPS), proximity sensors, light sensors, fingerprint sensors, accelerometer sensors, Hall effect sensors, a barometer, a compass, and many others. As shown, the MCU 803 may be in communication with such sensors 851, for instance, by way of a communication network or bus. In some implementations, the MCU 803 may be configured to control the operation of the sensors 851, as well as receive and transmit data and information corresponding with data captured by the sensors 851.

In some implementations, the MCU 803 may be configured to process, store, and/or transmit image data provided by an image sensor 807. For example, the MCU 803 may direct a camera to acquire a series of image frames while the mobile terminal 801 is moving along a pathway. The MCU 803 may tag the image data with a variety of information, including timestamps, positions, orientations, etc. As such, the MCU 803 may include or have access to a clock, position data, orientation data, and so forth. In some embodiments, the MCU 803 may be configured to carry out steps for controlling traffic, in accordance with methods described herein.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order. It should be appreciated that many equivalents, alternatives, variations, and modifications, aside from those expressly stated, are possible and may be considered within the scope of the invention.

1. A method for controlling traffic, the method comprising:
receiving vehicle information for a vehicle navigating a location on a road network;
identifying a maneuver of the vehicle at the location based on the vehicle information;
determining an intrusiveness of the maneuver made by the vehicle; and
controlling traffic at the location based on the intrusiveness of the vehicle.

2. The method of claim 1, wherein receiving the vehicle information further comprises receiving one or more properties of the vehicle, an origin of the vehicle, a destination of the vehicle, a vehicle position, a vehicle heading, a vehicle speed, or a combination thereof.

3. The method of claim 1, wherein the method further comprises estimating a pathway at the location corresponding to the maneuver by using the vehicle information and road information.

4. The method of claim 1, wherein the method further comprises computing an intrusiveness score.

5. The method of claim 4, wherein the method further comprises computing the intrusiveness score by using a number of vehicles at the location, a number of persons at the location, a number of obstructions at the location, a number of lanes at the location, a pathway of the maneuver, a duration of the maneuver, one or more delays, or a combination thereof.

6. The method of claim 1, wherein the method further comprises directing the vehicle in response to the intrusiveness.

7. The method of claim 6, wherein the method further comprises directing the vehicle to minimize the intrusiveness.

8. The method of claim 1, wherein the method further comprises directing other vehicles or persons in response to the intrusiveness of the vehicle.

9. A system for controlling traffic, the system comprising:
at least one communication module configured to transmit and receive information associated with vehicles navigating a location on a road network;
at least one processor in communication with the at least one communication module; and
a memory comprising instructions executable by the processor, the instructions causing the at least one processor to:
receive, using the at least one communication module, vehicle information for a vehicle navigating the location;
identify a maneuver to be made by the vehicle at the location based on the vehicle information;
determine an intrusiveness of the maneuver made by the vehicle; and
generate a report based on the intrusiveness of the vehicle.

10. The system of claim 9, wherein the at least one processor further receives one or more properties of the vehicle, an origin of the vehicle, a destination of the vehicle, a vehicle position, a vehicle heading, a vehicle speed, or a combination thereof.

11. The system of claim 9, wherein the at least one processor further estimates a pathway at the location corresponding to the maneuver by using the vehicle information and road information.

12. The system of claim 9, wherein the at least one processor further computes an intrusiveness score.

13. The system of claim 9, wherein the at least one processor further computes the intrusiveness score by using a number of vehicles at the location, a number of persons at the location, a number of obstructions at the location, a number of lanes at the location, a pathway of the maneuver, a duration of the maneuver, one or more delays, or a combination thereof.

14. The system of claim 9, wherein the at least one processor further generates a report to direct the vehicle in response to the intrusiveness.

15. The system of claim 9, wherein the at least one processor further generates a report to direct the vehicle to minimize the intrusiveness.

16. The system of claim 9, wherein the at least one processor further generates a report to direct other vehicles or persons in response to the intrusiveness of the vehicle.

17. A non-transitory computer-readable storage medium carrying one or more sequences of one or more instructions which, when executed by one or more processors, cause a system to perform steps to:
receive vehicle information for a vehicle navigating a location on a road network;
identify a maneuver to be made by the vehicle at the location based on the vehicle information;
determine an intrusiveness of the maneuver made by the vehicle; and
generate a report based on the intrusiveness of the vehicle.

18. The computer-readable storage medium of claim 17, wherein the one or more sequences further cause the system to compute an intrusiveness score by using a number of vehicles at the location, a number of persons at the location, a pathway of the maneuver, a duration of the maneuver, one or more delays, or a combination thereof.

19. The computer-readable storage medium of claim 17, wherein the one or more sequences further cause the system to generate a report based on the intrusiveness of the vehicle.

20. The computer-readable storage medium of claim 17, wherein the one or more sequences further cause the system to control traffic at the location based on the intrusiveness of the vehicle.
